(19) United States
(12) Patent Application Publication
(10) Pub. No.: US 2012/0165043 A1
(43) Pub. Date: Jun. 28, 2012

(54) MOBILE COMMUNICATION BASED TAGGING

(75) Inventors: THOMAS J. BURRIS, Pune (IN); ANANTH KALYAN CHAKRAVARTHY G, Visakhapatnam (IN)

(73) Assignee: INTERNATIONAL BUSINESS MACHINES CORPORATION, ARMONK, NY (US)

(21) Appl. No.: 13/411,019

(22) Filed: Mar. 2, 2012

Related U.S. Application Data
(63) Continuation of application No. 12/825,533, filed on Jun. 29, 2010.

(51) Int. Cl. H04W 24/00

(52) U.S. Cl. 455/456.1

(57) ABSTRACT

A plurality of tags can be generated by a user using the mobile electronic device and is associated with the current location of the mobile electronic device. A message can include metadata associated with the current location and at least a subset of tags from the plurality of tags. The message can be transmitted to a first system over a mobile communication network. The message received from the mobile electronic device can be stored in a repository of the first system. The first system can identify the current location of the mobile electronic device using the message. The system can parse the subset of tags and can maps the parsed subset of tags with the current location.

### CROSS-REFERENCE TO RELATED APPLICATIONS

This application is a continuation of U.S. patent application Ser. No. 12/825,533, filed Jun. 29, 2010 (pending), which is incorporated herein in its entirety.

### BACKGROUND

The present invention relates to the field of mobile electronic devices and, more particularly, to mobile communication based tagging.

Mobile electronic devices (e.g., cellular or mobile phones, personal digital assistants, etc.) have emerged as a widespread mode of communication in several countries around the world. Cellular phones have been able to gain relatively wider acceptance compared to the Internet, especially so in the developing world. Mobile electronic devices have, in recent times, become portable information exchange systems and entertainment centers having high end features such as multimedia capabilities including video, voice and textual. Short message service (SMS) is a mechanism of delivery of short messages over the mobile networks. SMS has gained relatively good popularity because of its low cost.

### SUMMARY

Embodiments of the disclosure are directed to a method, computer program product, system, and apparatus for tagging metadata associated with a current location. Embodiments of the disclosure generate a plurality of tags by a user using the mobile electronic device and associate the plurality of tags with the current location of the mobile electronic device. Embodiments further transmit, over a mobile communication network, a message that includes metadata associated with the current location and at least a subset of tags from the plurality of tags to a first system communicatively coupled to the mobile electronic device. In one embodiment, the message received from the mobile electronic device is stored in a repository of the first system and the current location of the mobile electronic device using the message can be identified. Embodiments further parse the subset of tags and map the parsed subset of tags with the current location. Identifying tags, mapping tags, and parsing tags can be performed by the first system.

### BRIEF DESCRIPTION OF THE SEVERAL VIEWS OF THE DRAWINGS

FIG. 1 depicts a schematic of tagging metadata associated with a current location in accordance with an embodiment of the disclosure;

FIG. 2 shows a schematic of tagging metadata associated with a current location in accordance with an embodiment of the disclosure;

FIG. 3 shows a schematic of fetching identifier metadata associated with a set of identifiers in accordance with an embodiment of the disclosure;

FIG. 4 shows a flow chart for tagging metadata associated with a current location as disclosed in an embodiment of the disclosure; and

FIG. 5 shows an exemplary schematic of a computer system on which FIGS. 1 to 4 may be implemented.

### DETAILED DESCRIPTION

The disclosure teaches a tagging methodology for mobile devices. The tagging performed herein can be social tagging and more specifically geospatially defined tags. For example, tags can be generated responsive to a user utilizing a mobile device. These tags can be automatically or user generated ones. Generated tags can be associated with a location of the mobile device. The tagging information and the location of the mobile device can be conveyed over a mobile communication network, where they are stored. In one embodiment, this stored information can be processed and added to internet available content.

Social tagging can refer to an association of a human-generated keyword—or “a tag”—with an entity. Typically, social tagging has primarily been an internet phenomenon, wherein Web users create tags to create an association with the web pages they are currently viewing. The usage on the internet of social tagging has shown that even a relatively small number of people actively tagging web pages can yield vast benefit for a very large number of users, and also benefit commercial sites and service providers. This in fact also, to some extent, is tied to the value created by Web 2.0 on the Internet. Social Tagging on the Web relates to users interacting with websites by associating tags with them.

Conventionally, there are two means by which a user can tag physical locations. A first means is by which users associate with an image the geographical coordinates at which the image was taken, and a second means is by tagging “geo-locations” via web applications. Some websites may be capable of allowing the users to socially tag geo-locations as web-based representations of physical locations. This is commonly known as “geo-tagging”.

The image-tagging approach indirectly tags physical locations in-so-far-as the users associating an image with a physical location and when a multitude of websites allow the users to tag the image. Through the image, therefore, the physical location associated with the image is tagged. The semantics of these tags, however, are not necessarily oriented toward the physical location and, therefore, this approach to physical location tagging may be limited. Typically, tags associated with locations through image-based tagging are semantically related to the image and not necessarily to the location, which may also introduce room for error.

In the case of “geo-tagging”, however, the interface for tagging is through a website. To tag a current location, where the user currently is using existing tools, the user would have to open a website that provides a map-based representation of the area at which the user is located, interact with the map to find the current location, select and type in tags. This type of tagging may be cumbersome due to an interface and it may make the spontaneity that has driven the success of social tagging on the web, weak. There may be cases when the current location map is not always easily available. The granularity available for geographic locations may be different in different tools. The accuracy of current approaches to geo-tagging via map-based websites is dependent on human interaction with representations of physical locations and thus may be susceptible to large error if either the resolution of the map is low or the user specifies a wrong location.

Portable electronic devices typically considered synonymous with mobile electronic devices, for example, cellular or mobile phones, personal digital assistants etc., have emerged as a widespread mode of communication in several countries around the world. Embodiments of the invention are directed to a method and systems for tagging metadata associated with a current location using a mobile electronic device. The current location of the user or a mobile electronic device, for example a mobile phone, personal digital assistant etc., may be gleaned from either GPS [Global Positioning System] coordinates if the mobile electronic device is GPS enabled, mobile communication network tower based location resolution, or a combination of both: for example, A-GPS [Assisted GPS].

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

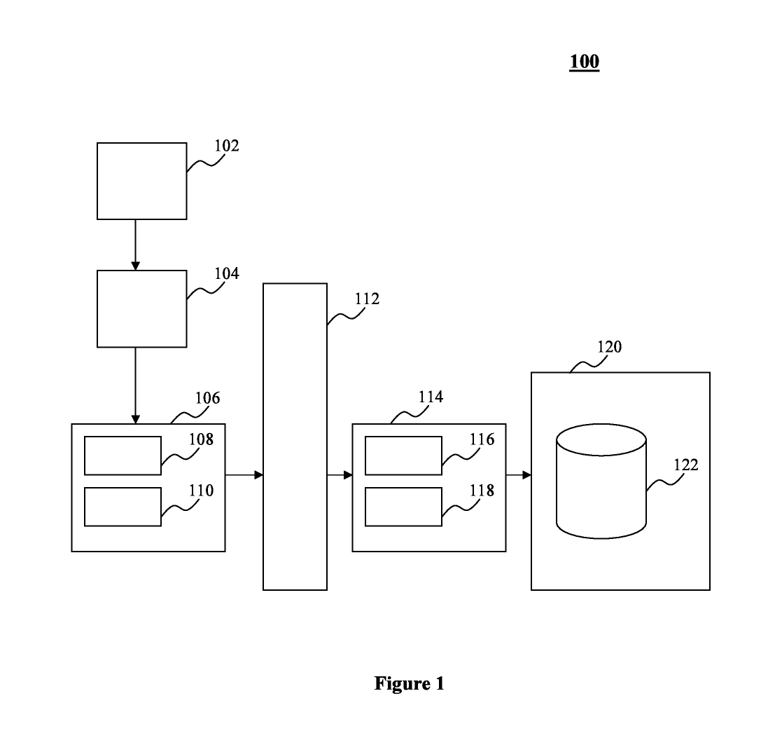

Turning to the figures, FIG. 1 depicts a schematic 100 of tagging metadata associated with a current location in accordance with an embodiment of the disclosure. FIG. 1 shows a user 102, a mobile electronic device 104, a first message 106, a second system 112, a second message 114, and a first system 120.

The user 102 may generate a plurality of tags using a mobile electronic device 104 and then associate the plurality of tags with the current location of mobile electronic device 104. First message 106 includes metadata 108 associated with the current location and at least a subset of tags 110 from the plurality of tags. First message 106 generated by user 102 of the mobile electronic device 104 is transmitted from the mobile electronic device 104 over a mobile communication network to second system 112, which is communicatively coupled to mobile electronic device 104. First message 106 is selected from at least one of a set of a text based communication, a voice based communication or a pre-defined communication mechanism associated with mobile electronic device 104.

Second system 112 is configured to: receive first message 106 from mobile electronic device 104 and modify first message 106 to generate second message 114. Second message 114, in an exemplary mode, includes metadata associated with the current location 116 and modified subset of tags 118. Some exemplary modifications may be, but not limited to: a conversion of analog format to digital format, a deletion or addition to parts of the tags or metadata. Second system 112 is configured to transmit second message 114 to first system 120 communicatively coupled to second system 112 over the mobile communication network. An exemplary second system 112 may be a gateway of a mobile network provider.

First system 120 includes at least one processor and at least one memory and the processor is adapted to: store second message 114 received from second system 112 in repository 122 of first system 120. In one embodiment, repository 122 has at least one of a structured data or an unstructured data. The processor of first system 120 is also configured to identify the current location of mobile electronic device 104 using second message 114, parse modified subset of tags 118, and map the parsed modified subset of tags with the current location. In one embodiment, some tags in relation to the current location may already stored in repository 122. These tags may or may not have been deposited by the mobile network. However, due to a multitude of factors, resolution of the mapped parsed modified subset of tags with previous data on tags may be necessary. One of the exemplary factors could be higher resolution of the current location using other modes, such as, for example, the Web. Yet another exemplary factor may be similar tags for the same current location, pre-existing in the repository. The processor is further configured to identify a first set of tags 110 associated with the current location, wherein the first set of tags is stored in repository 122, and resolve the parsed modified subset of tags with the first set of tags, if the first set of tags exists; and then map the resolved parsed modified subset of tags with the current location. The processor is also configured to store the mapped resolved parsed modified subset of tags in repository 122.

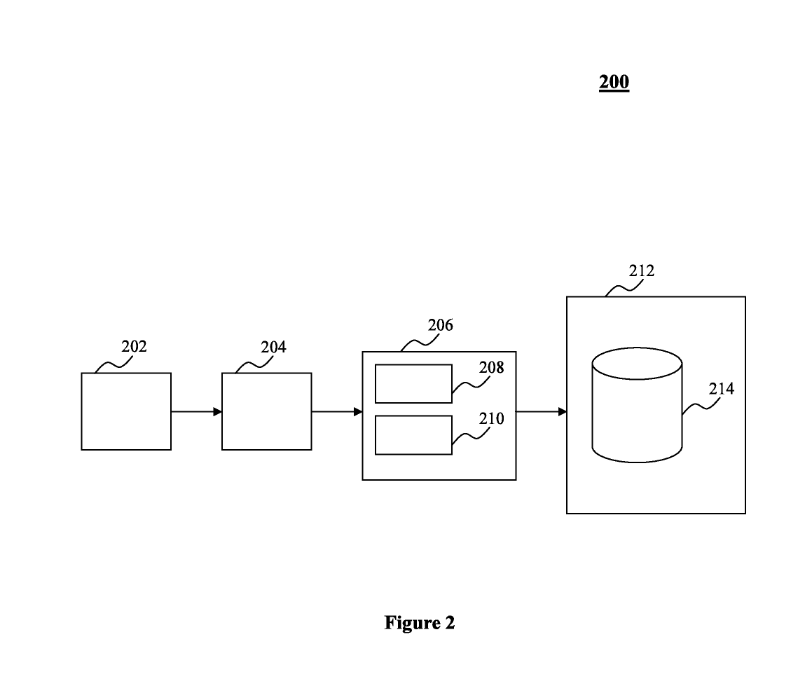

FIG. 2 shows a schematic 200 of tagging metadata associated with a current location in accordance with an embodiment of the disclosure. FIG. 2 shows a user 202, a mobile electronic device 204, a message 206, and a first system 212. Mobile electronic device 204 is configured to generate a plurality of tags by user 202 and associate the plurality of tags with the current location of mobile electronic device 204. Message 206 includes metadata 208 associated with the current location and at least a subset of tags 210 from the plurality of tags. Message 206 is transmitted from mobile electronic device 204 over a mobile communication network to first system 212, which is communicatively coupled to mobile electronic device 204. First message 206 is selected from at least one of a set of a text based communication, a voice based communication or a pre-defined communication mechanism associated with mobile electronic device 204.

FIG. 2 further depicts first system 212 including at least one processor and at least one memory and the processor is adapted to store message 206 received from mobile electronic device 204 in repository 214 of first system 212. First system 212, in one embodiment, may also include a gateway adapted to convert analog input to digital format. Repository 214 includes at least one of a structured data or an unstructured data. The processor of first system 212 is also configured to identify the current location of mobile electronic device 204 using message 206, parse subset of tags 210, and map the parsed subset of tags with the current location. There may be some tags already stored in repository 214. These tags may or may not have been deposited by the mobile network. However, due to a multitude of factors, resolution of the mapped parsed modified subset of tags with previous data on tags may be necessary. One of the factors could be higher resolution of the current location using other modes, such as, for example, the Web. Yet another factor may be similar tags for the same current location, pre-existing in the repository.

The processor is further configured to identify a first set of tags associated with the current location. The first set of tags is stored in repository 214. The processor is configured to resolve the parsed subset of tags with the first set of tags, if the first set of tags exists; and map the resolved parsed subset of tags with the current location. The processor is also configured to store the mapped resolved parsed subset of tags in repository 214.

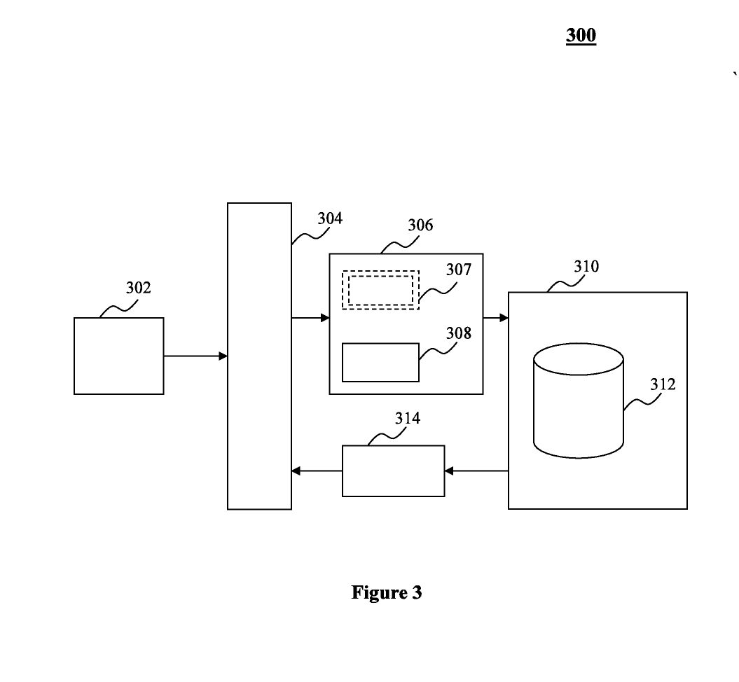

FIG. 3 shows a schematic 300 of fetching identifier metadata associated with an identifier set in accordance with an embodiment of the disclosure. FIG. 3 shows a user 302, a mobile electronic device 304, a request 306, a first system 310, and a result 314. Request 306 may include a current location metadata 308 and may optionally include an identifier set 307. Identifier set 307 may include but is not limited to user defined tags, phone numbers, additional geographical information etc. First system 310 is configured to access a repository 312. In one embodiment, first system 310 may include repository 312. Repository 312 is configured to have a plurality of mapped identifiers, the plurality of mapped identifiers being generated using processing of a set of inputs sent by a plurality of users of mobile electronic devices. First system 310 is also configured to parse identifier set 307 received from mobile electronic device 304 communicatively coupled to first system 310 over a mobile electronic network.

First system 310 is also configured to fetch identifier metadata associated with identifier set 307 from repository 312 having a plurality of mapped identifiers. In one embodiment, repository 312 is communicatively coupled to first system 310. First system 310 is also configured to transmit result 314 including identifier metadata to mobile electronic device 304 over the mobile electronic network.

FIG. 3 further depicts mobile electronic device 304 being configured to generate request 306 by user 302 using mobile electronic device 304 and request 306 includes an identifier set 307. Mobile electronic device 304 is also configured to transmit request 306 to first system 310 over the mobile communication network, receive the identifier metadata from first system 310, and display the identifier metadata to user 302 of mobile electronic device 304. First system 310 is further configured to receive request 306 from mobile electronic device 304.

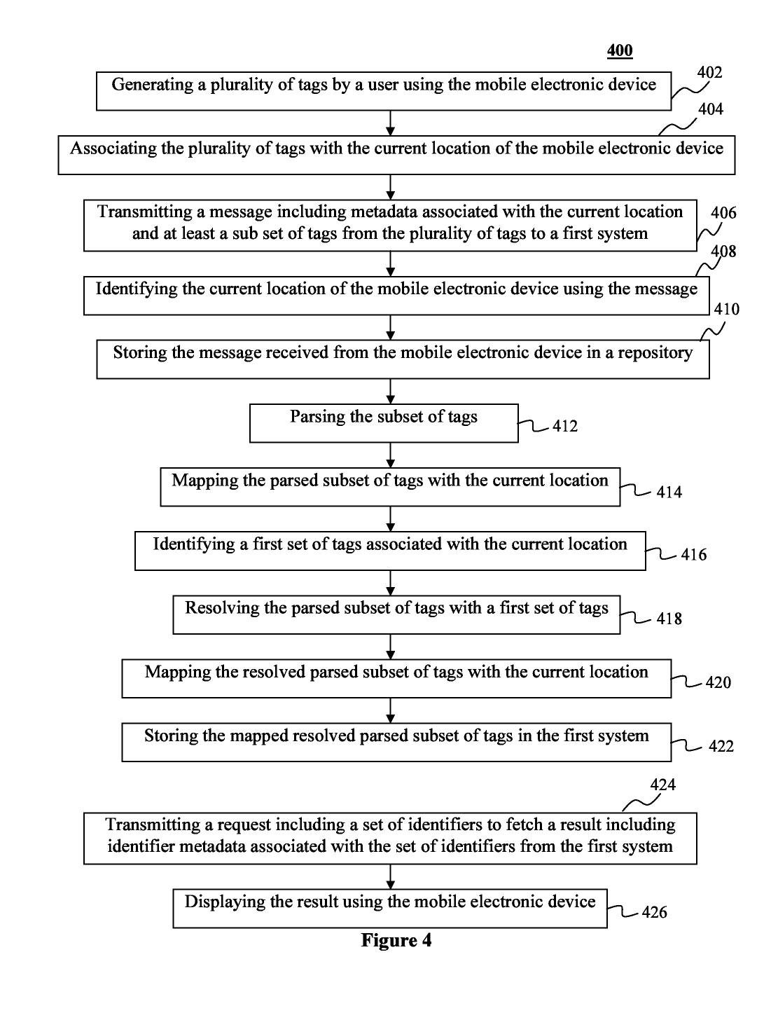

FIG. 4 shows a flow chart of a method 400 for tagging metadata associated with a current location as disclosed in an embodiment of the invention. In one contemplated mode, the current location may be a famous landmark where the user is currently located. In step 402 a plurality of tags is generated by a user using the mobile electronic device. In one contemplated mode, the plurality of tags may include tags, for example, a restaurant type or name nearby, or a particular type of vendor. In step 404 the plurality of tags is associated with the current location of the mobile electronic device. In step 406, a message including metadata associated with the current location and at least a subset of tags from the plurality of tags associated with the current location is transmitted to a first system communicatively coupled to the mobile electronic device over a mobile communication network. In one contemplated mode, the metadata of the current location may be Cartesian co-ordinates or a combination of latitude and longitude of that location. Once this message is sent over the mobile communication network, it is received by the first system. One example of the first system can be a server that receives the message.

In step 408 the first system is adapted to identify the current location of the mobile electronic device using the message generated by the user. In step 410, the first system can store the message received from the mobile electronic device in a repository. The repository can include structured data and/or unstructured data. In one embodiment, the repository may be included in the first system. In one embodiment, the repository may be functionally coupled to the first system, but be remotely located from it. The structured data may be in the form of an RDBMS (Relational Data Base Management System). Unstructured data may be formatted in accordance with standards of a file system.

The first system, in step 412, depicts parsing the subset of tags. In one contemplated mode, parsing may include conversion of voice message into a digital data, which is conveyable in an encoded form via a carrier wave. The encoded form can be as a text message, as an attachment, as a VoIP communication, and other such message formats. Regardless of format, the conveyed message(s) can be processed in the server of the first system in one embodiment of the disclosure.

In step 414 the parsed subset of tags is mapped with the current location of the mobile electronic device. Steps 416, 418, and 420 depict a particular case where there may be some tags already stored in the repository. These tags may or may not have been deposited by the mobile network. However, due to a multitude of factors, resolution of the mapped parsed tags of step 414 with previous data on tags may be necessary. One of the factors could be higher resolution of the current location using other modes, such as, for example, the Web. Yet another factor may be similar tags for the same current location, pre-existing in the repository.

Steps 416, 418, 420 and 422 together depict resolving pre-existing tags in the repository for the current location of the mobile electronic device. In step 416, a first set of tags associated with the current location is identified, wherein the first set of tags is stored in the first system. The first set of tags can be isolated from the pre-existing tags associated with the current location. In step 418 the parsed subset of tags with the first set of tags can be resolved, assuming the first set of tags exists. Some exemplary modes of the resolution may include, but are not limited to superimposing, deleting, editing, attaching and removing. Having achieved the resolution, in step 420, the resolved parsed subset of tags are mapped with the current location. In step 422, the mapped resolved parsed subset of tags are stored in the first system.

Step 424 and step 426 together depict using the first system having pre-populated repository using a multitude of sources of social tagging, of which at least one is a mobile electronic device, as described from step 402 through step 422. Step 424 depicts the mobile electronic device transmitting a request including an identifier set, to fetch a result that includes a plurality of identifier metadata associated with the identifier set, from the first system. The identifier set may include but is not limited to, geographical data of the mobile electronic device, a tag associated with a current location, a phone number of the mobile electronic device, and other such data. A plurality of identifier metadata associated with the identifier set may include but is not limited to, geographical data of the mobile electronic device, a tag associated with an identifier, geographical metadata associated with the identifier, and the like. Step 426 depicts displaying the result using the mobile electronic device.

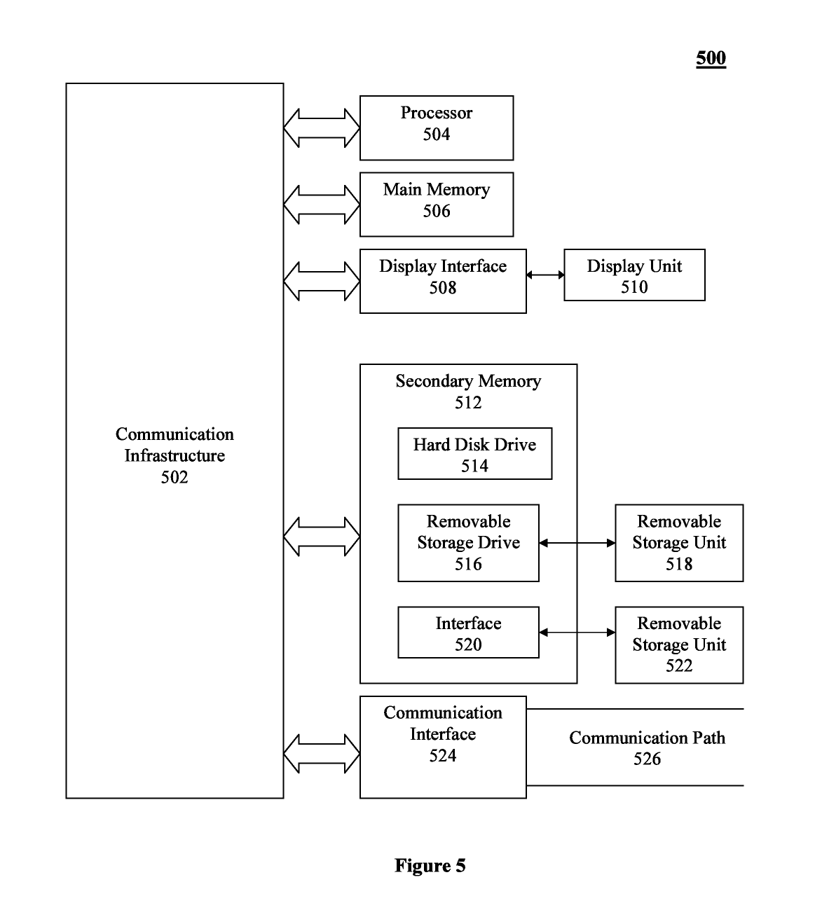

FIG. 5 shows a detailed schematic of a computer system used for creating a set of identifiers. FIG. 5 is a block diagram of an computer system 500 that can be used for implementing various embodiments of the disclosure. For example, the computer system 500 can be used as a system executing any one of the schematic 100 of FIG. 1, the schematic 200 of FIG. 2, the schematic 300 of FIG. 3, and/or can be used to perform the method 400 described in FIG. 4.

The computer system 500 includes at least a processor 504. It should be understood although FIG. 5 illustrates a single processor, one skilled in the art would appreciate that more than one processor can be included as needed. Similarly, the processor 504 can include one or more processing cores.

The processor 504 is connected to a communication infrastructure 502 (for example, a communications bus, cross-over bar, or network) where the communication infrastructure 504 is configured to facilitate communication between various elements of the computer system 500. Various software embodiments are described in terms of this exemplary computer system. After reading this description, it will become apparent to a person of ordinary skill in the relevant art(s) how to implement the disclosure using other computer systems and/or computer architectures. The software embodiments of system 500 can be stored on a tangible, non-transient storage medium (such as memory 506 and/or 512). Additionally, the processor 504 can execute instructions of any of the software (or firmware) of the software embodiments.

The computer system 500 can include a display interface 508 configured to forward graphics, text, and other data from the communication infrastructure 502 (or from a frame buffer not shown) for display on a display unit 510. The computer system 500 also includes a main memory 506, which can be a volatile memory, such as a random access memory (RAM).

System 500 can include a non-volatile memory referenced as secondary memory 512. The secondary memory 512 may include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a manner well known to those having ordinary skill in the art. The removable storage unit 518, represents, for example, a floppy disk, magnetic tape, optical disk, etc. which is read by and written to by the removable storage drive 516. As will be appreciated, the removable storage unit 518 includes a computer usable storage medium having stored therein computer software and/or data.

In contemplated embodiments, the secondary memory 512 may include other similar means for allowing computer programs or other instructions to be loaded into the computer system. Such means may include, for example, a removable storage unit 522 and an interface 520. Examples of such may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to the computer system 500.

The computer system 500 may also include a communications interface 524. The communications interface 524 allows software and data to be transferred between the computer system and external devices. Examples of the communications interface 524 may include a modem, a network interface (such as an Ethernet card), a communications port, a PCMCIA slot and card, etc. Software and data transferred via the communications interface 524 are in the form of signals which may be, for example, electronic, electromagnetic, optical, or other signals capable of being received by communications interface 524. These signals are provided to the communications interface 524 via a communications path (that is, channel) 526. The channel 526 carries signals and may be implemented using wire or cable, fiber optics, a phone line, a cellular phone link, an RF link, and/or other communications channels.

The terms “computer program medium,” “computer usable medium,” and “computer readable medium” as used herein may refer to media such as the main memory 506 and the secondary memory 512, the removable storage drive 516, a hard disk installed in the hard disk drive 514, and the like. Further, transmission medium able to carry digitally encoded information in carrier ways is presumed to exist in system 500.

Computer programs (also referred to as computer control logic or computer program products, software, or firmware) are stored in the main memory 506 and/or the secondary memory 512. Computer programs may also be received via the communications interface 524. Such computer programs, when executed, can enable the computer system 500 to perform the features of embodiments of disclosure as discussed herein. In particular, the computer programs, when executed, enable the processor 504 to perform the features of the computer system 500. Accordingly, such computer programs represent controllers of the computer system 500.

Advantages of various embodiments of the invention include less dependence on the Web, photo-images or photographs for tagging locations. Advantages of various embodiments of the invention further include participatory and social tagging using a growing mode of communication, viz. mobile electronic devices connected over the mobile networks. Advantages of various embodiments of the invention also include reduced cost of generating location tagging, facilitation of more targeted advertizing, simpler fetching of more meaningful and useful data about various identifiers including geographic locations. Advantages of various embodiments of the invention also include harnessing widespread a multitude of mobile electronic devices connected over popular mobile network based communication, for peer to peer communication for content exchange. Advantages of several embodiments of the invention further include the capability of various users interactively communicating by associating tags with the geographical locations, which may allow a large array of commercially exploitable services around physical locations and semantically rich tagging.

The described techniques may be implemented as a method, apparatus or article of manufacture involving software, firmware, micro-code, hardware such as logic, memory and/or any combination thereof. The term “article of manufacture” as used herein refers to code or logic and memory implemented in a medium, where such medium may include hardware logic and memory [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also include transmission signals propagating through space or a transmission media, such as an optical fiber, copper wire, etc. The transmission signal in which the code or logic is encoded may further include a wireless signal, satellite transmission, radio waves, infrared signals, Bluetooth, the internet etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may include a combination of hardware and software components in which the code is embodied, processed, and executed. Of course, those skilled in the art will recognize that many modifications may be made without departing from the scope of embodiments, and that the article of manufacture may include any information bearing medium. For example, the article of manufacture includes a storage medium having stored therein instructions that when executed by a machine results in operations being performed.

Elements that are in communication with each other need not be in continuous communication with each other, unless expressly specified otherwise. In addition, elements that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Although exemplary embodiments of the disclosure have been described in detail, it should be understood that various changes, substitutions and alternations could be made thereto without departing from spirit and scope of the disclosure as defined by the appended claims. Variations described for exemplary embodiments of the disclosure can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to embodiments of the disclosure.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A mobile electronic device implemented method for tagging metadata associated with a current location, the method comprising:
generating a plurality of tags by a user using the mobile electronic device; associating the plurality of tags with a current location of the mobile electronic device; and
transmitting, a message including metadata associated with the current location and at least a subset of tags from the plurality of tags to a first system communicatively coupled to the mobile electronic device over a mobile communication network.

2. The method of claim 1, wherein the message is selected from at least one of a set of a text based communication, a voice based communication, and a pre-defined communication mechanism associated with the mobile electronic device.

3. The method of claim 1, further comprising:
storing the message received from the mobile electronic device in a repository, wherein the repository is associated with the first system.

4. The method of claim 3, wherein the repository includes unstructured data.

5. The method of claim 3, further comprising:
performing on the first system:
identifying the current location of the mobile electronic device using the message;
parsing the subset of tags; and
mapping the parsed subset of tags with the current location.

6. The method of claim 5, further comprising:
identifying a first set of tags associated with the current location, wherein the first set of tags is obtained from the first system;
resolving the parsed subset of tags with the first set of tags, if the first set of tags exists;
mapping the resolved parsed subset of tags with the current location; and storing the mapped resolved parsed subset of tags in the first system.

7. The method of claim 6, further comprising:
transmitting a request to fetch a result from the first system, the request transmitted by the mobile electronic device, wherein the request includes an identifier set, and the result includes a plurality of identifier metadata associated with the identifier set; and
displaying the result to the user on the mobile electronic device.
